(19) United States
(12) Patent Application Publication
(10) Pub. No.: US 2019/0387153 A1
(43) Pub. Date: Dec. 19, 2019

(54) IMAGING RESOLUTION AND TRANSMISSION SYSTEM

(71) Applicant: Honeywell International Inc., Morris Plains, NJ (US)

(72) Inventors: Robert E. De Mers, Nowthen, MN (US); Charles T. Bye, Eden Prairie, MN (US); Ryan Supino, Loretto, MN (US)

(73) Assignee: Honeywell International Inc., Morris Plains, NJ (US)

(21) Appl. No.: 16/008,967

(22) Filed: Jun. 14, 2018

(51) Int. Cl. H04N 5/232; H04N 7/04; H04N 7/01; H04N 5/44

(52) U.S. Cl. CPC H04N 5/23206; H04N 7/04; H04N 5/4403; H04N 7/0117; H04N 5/23216

(57) ABSTRACT

The present application discloses an image resolution and transmission system in which a user can advantageously select one or more areas of interest to be captured and transmitted by a remote camera. Using a set of tools available on a computing device with a display, a user selects parameters such as location, shape and size of the area(s) of interest. Upon receiving one or more control signals, the remote camera transmits image data for the selected area(s) of interest at one or more optimal resolutions based on the available transmission bandwidth.

### BACKGROUND

In many image processing systems, cameras are used to capture image data and transmit the data to one or more recipients at remote locations. In some cases, for example, a remote camera installed on an unmanned aerial vehicle (UAV) may be used for inspecting infrastructure or collecting image data about another target of interest. The transmission rate of the image data, or data flow rate, is often limited by the available bandwidth.

In some cases, the issue of limited bandwidth is addressed by storing a high-resolution image or video at the remote camera location, e.g., onboard a UAV. The remote camera transmits only a low-resolution version of the image or video to the user. When high-resolution images or video are needed, a number of approaches can be utilized.

For example, in some cases, the entire high-resolution image is transmitted over a period of seconds, while interrupting the real-time video. In other cases, the remote camera uses available bandwidth to transmit high priority portions of the image or video at higher resolutions. For example, using foveal imaging techniques, the available bandwidth can be used to always transmit the center of the image in high resolution (foveal view), or transmit portions of the video that are changing.

The existing approaches described above suffer from a number of drawbacks. For example, in some cases certain portions of the image or video may be transmitted to a user in high resolution, even though the user desires to receive different portions of the image or video in high resolution. In some cases, a relatively low transmission rate may be selected in order to transmit a large portion of the image or video in high resolution, even though the user would prefer to receive the image data at a higher transmission rate with a smaller portion of the image or video in high resolution.

To provide a specific example, if a user is unable to view a high-resolution image of an area of concern while a UAV is airborne, frequently the user will trigger the capture of a high-resolution image, which is stored on the UAV. After the flight is completed, the image is downloaded. The user then reviews the image stored on the UAV and determines whether it is adequate and usable. If not, then the UAV is flown back to the location where the image was taken, and a new image or video is acquired. This approach is often inefficient and costly.

### SUMMARY

The present application discloses an image resolution and transmission system in which a user can advantageously select parameters such as location, shape and size of one or more areas of interest within a field of view of a remote camera, to be captured and transmitted at high resolution.

In one embodiment, a system comprises a first computing device coupled to a camera, the first computing device being configured to process data captured by the camera to create and transmit video and image data. The system further comprises a second computing device in communication with the first computing device and coupled to a display, the second computing device being configured to receive and display video and image data transmitted by the first computing device. The second computing device is configured to generate and transmit one or more control signals, in response to user input, designating a location, shape and size of one or more selected areas of interest within a field of view of the camera. The first computing device is configured, upon receiving the control signal(s), to transmit video data at multiple resolutions, with the selected area(s) of interest transmitted at high resolution and the unselected area(s) within the field of view of the camera transmitted at lower resolution, after automatically reducing the resolution of the unselected areas if needed to make use of the available transmission bandwidth. The second computing device is configured, upon receiving the video data transmitted at multiple resolutions, to generate and display composite video comprising a low-resolution area and one or more high-resolution areas of interest, as designated by the user.

The the first computing device and second computing device may comprise one or more of the following devices: an embedded computer, desktop computer, laptop computer, tablet, smart phone, PDA, or wearable device. The second computing device may comprise one or more of the following user input devices: a mouse, touchpad, arrow keys, joystick, capacitive touchscreen, resistive touchscreen, stylus, digital pen, or speech recognition. The first computing device and second computing device may be in communication via a telecommunications network comprising a wired network, wireless network, radio-based data transmission system modulated laser-based communication system, ACARS network, local area network (LAN), wide area network (WAN), personal area network (PAN), a distributed computing environment (e.g., a cloud computing environment), storage area network (SAN), Metropolitan area network (MAN), a cellular communications network, or the Internet. The first computing device and camera may be positioned at a fixed location remote from the second computing device. The first computing device and camera may be carried or mounted on a ground vehicle, watercraft or aircraft located remotely from the second computing device. The camera may have a resolution within a range of less than about 1 megapixel to about 50 megapixels. The control signal(s) designating a location, shape and size of the area(s) of interest may be generated in response to a user using one or more of the following selection tools: grid, free-form, or snap-to lasso. The selected area(s) of interest may comprise multiple independent regions of interest within the field of view of the camera.

In another embodiment, a method comprises capturing high-resolution video data with a first computing device having a camera, and transmitting the video data to a second computing device at first, nominal resolution. The method further comprises receiving one or more control signals from the second computing device, the control signal(s) designating a location, shape and size of one or more selected areas of interest within a field of view of the camera. The method further comprises, in response to receiving the control signal(s), estimating a bandwidth required to transmit the selected area(s) of interest at a second, high resolution and determining whether sufficient bandwidth is available to transmit the selected area(s) of interest at the second resolution while continuing to transmit the unselected area(s) within the field of view of the camera at the first resolution, If sufficient bandwidth is not available, the method further comprises reducing the resolution of at least some portions of the unselected area(s) to a third resolution that is lower than the first resolution. The method further comprises transmitting video data at multiple resolutions, with the selected area(s) of interest transmitted at the second resolution and the unselected area(s) within the field of view of the camera transmitted at: (a) the first resolution, (b) the third resolution, or (c) multiple resolutions including both the first resolution and the third resolution.

The method may further comprise tracking one or more objects of interest with the camera over time, wherein the object(s) of interest are determined based on the selected area(s) of interest designated by the user. The first computing device may comprise an embedded computer. The video data may he transmitted at the first resolution in accordance with NTSC or PAL standards. Reducing the resolution of at least some portions of the unselected area(s) may comprise linearly decreasing the resolution as the distance away from the selected area(s) of interest increases. Reducing the resolution of at least some portions of the unselected area(s) may comprise identifying an optimal resolution based on available bandwidth. Transmitting video data at multiple resolutions may comprise transmitting multiple partial video files at different resolutions.

In another embodiment, a method comprises receiving video data transmitted at a first, nominal resolution from a first computing device with a camera, at a second computing device with a display. The method further comprises generating, in response to user input, one or more control signals designating a location, shape and size of one or more selected areas of interest within a field of view of the camera, wherein the user input comprises a user selecting a desired location on the display of the second computing device with a user input device, thereby causing a selection window to appear on the display, which continues to expand in size as long as the user continues to press and hold the user input device. The method further comprises transmitting the control signal(s) to the first computing device; and receiving, from the first computing device, video data transmitted at multiple resolutions, with the selected area(s) of interest transmitted at a second, high resolution and the unselected area(s) within the field of view of the camera transmitted at: (a) the first resolution, (b) a third resolution lower than the first resolution, or (c) multiple resolutions including both the first resolution and the third resolution. The method further comprises, in response to receiving the video data at multiple resolutions, generating and displaying composite video comprising a low-resolution area and one or more high-resolution areas of interest, as designated by the user.

The second computing device may comprise one or more of the following user input devices: a mouse, touchpad, arrow keys, joystick, capacitive touchscreen, resistive touchscreen, stylus, digital pen, or speech recognition. The selection window may comprise a circle, square, or rectangle. Generating the composite video may comprise combining multiple partial video files transmitted at different resolutions by the first computing device.

In another embodiment, a system comprises a first computing device coupled to a camera, and a second computing device in communication with the first computing device and coupled to a display. The first computing device is configured to process data captured by the camera to create and transmit video and image data. The second computing device is configured to receive and display video and image data transmitted by the first computing device. The second computing device is also configured to generate and transmit one or more first control signals, in response to user input, indicating the presence of a point of interest within a field of view of the camera. The first computing device is configured, upon receiving the first control signal(s), to record a high-resolution still image and transmit a low-resolution version of the still image to the second computing device, which is configured to generate and transmit one or more second control signals, in response to user input, designating a location, shape and size of one or more desired areas of interest in the still image. Upon receiving the second control signal(s), the first computing device is configured to transmit high-resolution image data corresponding to the selected area(s) of interest. The second computing device is configured, upon receiving the high-resolution image data, to generate and display a composite still image comprising a low-resolution area and one or more high-resolution areas of interest, as designated by the user.

In another embodiment, a method comprises receiving low-resolution video data transmitted from a first computing device with a camera at a second computing device with a display; generating, in response to user input, one or more first control signals indicating the presence of a point of interest within a field of view of the camera; and transmitting the first control signal(s) to the first computing device. The method further comprises receiving a low-resolution still image from the first computing device; generating, in response to user input, one or more second control signals designating a location, shape and size of one or more selected areas of interest in the low-resolution still image; and transmitting the second control signal(s) to the first computing device. The method further comprises receiving, from the first computing device, high-resolution image data corresponding to the selected area(s) of interest; and in response to receiving the high-resolution image data, generating and displaying a composite still image comprising a low-resolution area and one or more high-resolution areas of interest, as designated by the user.

In another embodiment, a method comprises capturing and transmitting low-resolution video data with a first computing device having a camera; receiving one or more first control signals from a second computing device, the first control signal(s) indicating the presence of a point of interest within a field of view of the camera; and in response to receiving the first control signal(s), recording a high-resolution still image and transmitting a low-resolution version of the still image to the second computing device. The method further comprises receiving one or more second control signals from the second computing device, the second control signal(s) designating a location, shape and size of one or more selected areas of interest in the still image; and in response to receiving the second control signal(s), transmitting high-resolution image data corresponding to the selected area(s) of interest.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1, illustrates one embodiment of a remote camera system with enhanced imaging resolution and transmission features;

FIG. 2 illustrates an exemplary method of operating a remote camera system with enhanced imaging resolution and transmission features, to transmit one or more still images; and

FIG. 3 illustrates another exemplary method of operating a remote camera system with enhanced imaging resolution and transmission features, to transmit video data.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

As described above, in many remote camera systems, the transmission of full high-resolution images is not possible due to limited data bandwidth. Foveal imaging has been used in the past to address the issue of limited bandwidth in image transmission systems. Foveal imaging involves transmitting high-resolution data for the center of the camera view, leaving low-resolution around it. Foveal imaging is similar in concept to the way human eyes work, and it works well in some instances. However, the center of the image may not be the area of the image that the user desires to view in high resolution. The present application describes a number of systems and methods that overcome the disadvantages of conventional foveal imaging, and enable the user to select a desired area for high-resolution viewing.

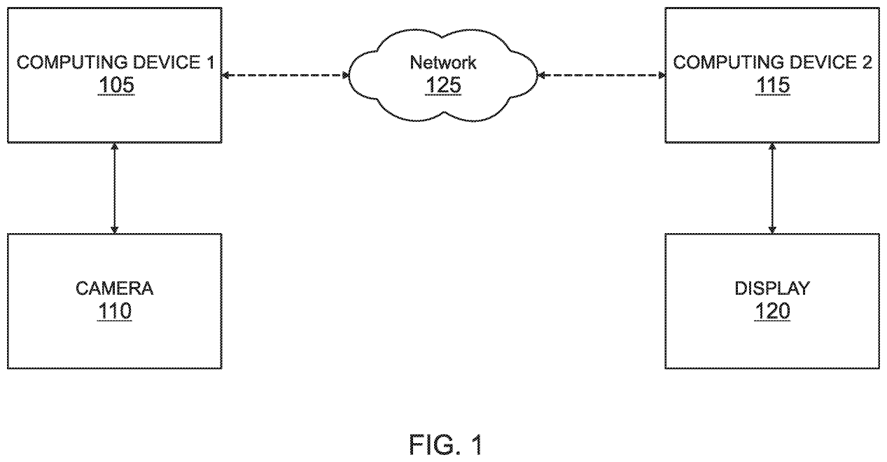

FIG. 1 illustrates one embodiment of a remote camera system 100. In the illustrated embodiment, the system 100 comprises a first computing device 105 coupled to a camera 110, which is in communication with a second computing device 115 coupled to a display 120. The first computing device 105 and second computing device 115 may comprise a wide variety of suitable devices that include components such as a central processing unit (CPU), memory, communication interface, etc. For example, in some embodiments, a computing device may comprise an embedded computer, desktop computer, laptop computer, tablet, smart phone, personal digital assistant (PDA), wearable device, etc. In addition, a computing device, particularly the second computing device 115, may comprise a capacitive touchscreen, resistive touchscreen, or another suitable touchscreen user input device.

The first computing device 105 and second computing device 115 are in communication via a network 125, which may comprise a wide variety of suitable telecommunications networks. For example, in some embodiments, network 125 comprises a wired or wireless network such as a radio-based data transmission system, modulated laser-based communication system, ACARS network, local area network (LAN), wide area network (WAN), personal area network (PAN), a distributed computing environment (e.g., a cloud computing environment), storage area network (SAN), Metropolitan area network (MAN), a cellular communications network, and/or the Internet, etc.

In some embodiments, the first computing device 105 and camera 110 are positioned at a fixed location, such as a security monitoring location or an inspection station, etc. In other embodiments, the first computing device 105 and camera 110 are mobile. In some cases, for example, the first computing device 105 and camera 110 are carried or mounted on a suitable ground vehicle, watercraft or aircraft, such as an unmanned aerial vehicle (UAV), etc. In one specific embodiment, for example, the first computing device 105 and camera 110 are installed on a UAV, which is used for inspecting infrastructure.

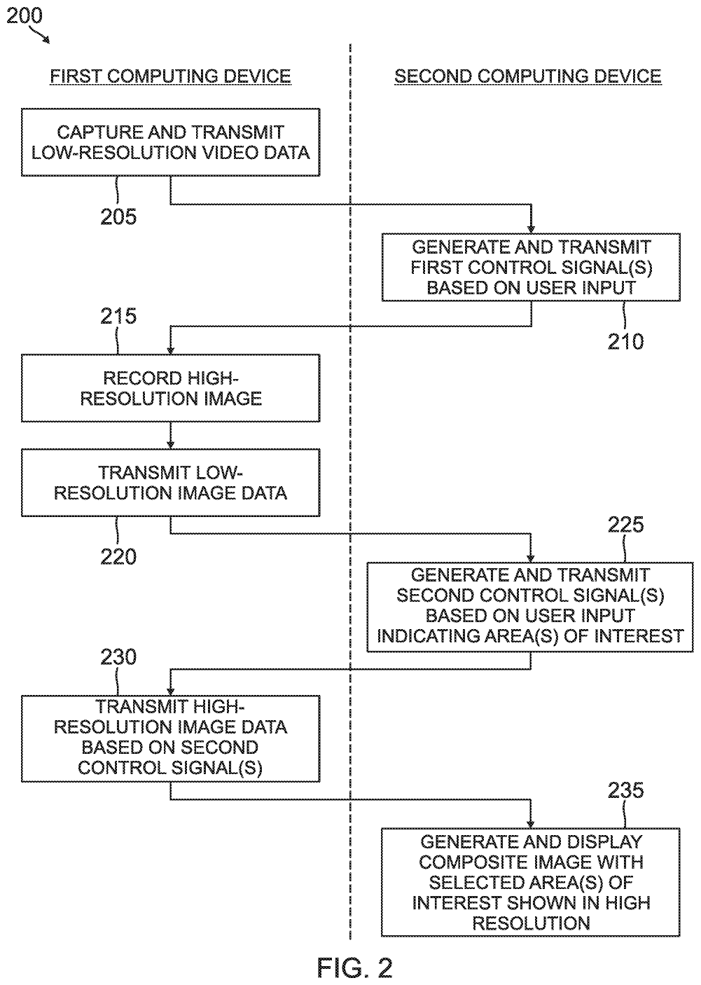

FIG. 2 illustrates an exemplary method 200 of operating the remote camera system 100 to transmit one or more still images. In a first step 205, the first computing device 105 and camera 110 capture and transmit image data in low resolution to the second computing device 115. The image data may comprise video footage or a sequence of still images captured by the camera 110.

The frame rate and transmission rate of the image data can vary widely, depending on the circumstances. In some embodiments, for example, the image data may be captured and transmitted in accordance with NTSC or PAL standards, which are incorporated herein by reference in their entireties. In other embodiments, the image data may have a lower or higher frame rate and/or transmission rate, e.g., for scenarios involving time-lapse photography or high-speed photography. In one specific example, the first computing device 105 and camera 110 are mounted on a UAV and configured to continuously transmit video data at a nominal resolution in accordance with NTSC standards to the second computing device 115 and display 120.

The resolution of the image data can also vary widely, depending on the circumstances. In some embodiments, for example, the camera 110 has a resolution within the range of less than 1 megapixel to about 50 megapixels or higher. The nominal resolution of the video data is often affected or controlled by the available transmission bandwidth.

The second computing device 115 receives the low-resolution image data and shows it on the display 120. A user operating the second computing device 115 can provide user input when a point of interest is seen in the low-resolution image data. In response to such user input(s), in a next step 210, the second computing device 115 generates and transmits one or more first control signals directing the first computing device 105 to record a high-resolution still image. The first control signal(s) indicate that a point of interest is within the field of view of the camera 110.

Upon receiving the first control signal(s), in a step 215, the first computing device 105 uses the camera 110 to capture and record a high-resolution still image, which preferably includes the point of interest. In some embodiments, the high-resolution still image and a corresponding low-resolution version of the same image are saved in a local memory of the first computing device 105. In a next step 220, the first computing device 105 transmits the low-resolution version of the still image to the second computing device 115, where it is shown on the display 120.

A user operating the second computing device 115 can view the low-resolution still image and select one or more areas in which high-resolution image data are desired. The user can designate parameters such as a location, shape and size of the desired high-resolution area(s), using a variety of suitable techniques, some examples of which are described below. The user can select the desired area(s) of interest using a variety of suitable user input devices, such as, for example, a mouse, touchpad, arrow keys, joystick, touchscreen, stylus, digital pen, speech recognition, etc.

In some embodiments, for example, the user designates the area(s) of interest by selecting a desired location on the display 120 of the second computing device 115, which causes a selection window to appear on the display 120. The selection window continues to expand in size as long as the user continues to press and hold the user input device. In some cases, the user input device comprises a touchscreen, and the user can select the location, shape and size of the high-resolution area or low-resolution area simply by pressing the display 120 at the desired location and continuing to press and hold the display 120 until the selection window reaches the desired shape and size.

In some embodiments, as the user continues to press and hold the user input device, the display 120 shows the estimated download time related to the expanding high-resolution area. By updating and displaying the estimated download time, the user can advantageously select a desired trade-off between the desired high-resolution area and the associated download time.

In some embodiments, the selection window comprises a circle, which appears on screen at the selection point and expands radially as long as the user continues to press and hold the user input device. In other embodiments, the selection window comprises another suitable shape (e.g., square, rectangle, etc.), which the user can select using a variety of selection tools, such as grid, free-form, snap-to lasso, etc. The area can be extended beyond the shape, if the user selects the shape. In some embodiments, the user can select multiple independent regions of interest within the same image to be transmitted in high resolution.

Once the user has designated the area(s) of interest, in a step 225, the second computing device 115 generates one or more second control signals and transmits the second control signal(s) to the first computing device 105. The second control signal(s) indicate parameters such as the location, shape and size of the area(s) of interest selected by the user.

Upon receiving the second control signal(s), in a step 230, the first computing device 105 transmits high-resolution image data for the selected area(s) of interest to the second computing device 115, in accordance with the parameters indicated in the second control signal(s). In some embodiments, the high-resolution image data is retrieved from the local memory of the first computing device 105.

Upon receiving the high-resolution image data, in a step 235, the second computing device 115 generates and displays a composite still image showing the selected area(s) of interest in high resolution. In sonic embodiments, the second computing device 115 generates the composite still image by mapping the high-resolution image data onto the existing low-resolution image, creating a new image with a combination of high- and low-resolution areas.

To provide one specific example, the first computing device 105 and camera 110 are mounted on a UAV used for inspecting infrastructure. Upon receiving a first control signal indicating the presence of one or more points of interest, the camera 110 captures a high-resolution still image, which is saved in a local memory of the first computing device 105 onboard the UAV. The first computing device 105 then transmits a low-resolution version of the still image to the second computing device 115. Using a set of tools available on the second computing device 115 and display 120, the user identifies one or more areas of interest, either point or region. If the user continues to press and hold the user input device, then command signals are generated specifying how the high-resolution area should be expanded. The second computing device 115 then sends the command signals, e.g., a map of the designated area(s) of interest that were specified by the user, and transmits the command signals to the UAV. The first computing device 105 then separates out the high-resolution image data for the selected area(s) of interest from the high-resolution image file saved in local memory onboard the UAV, and transmits the high-resolution image data to the user at a ground station. The high-resolution image portions are then overlaid on the low-resolution image at the ground station and a composite still image is displayed to the user, with the selected area(s) of interest shown in high resolution.

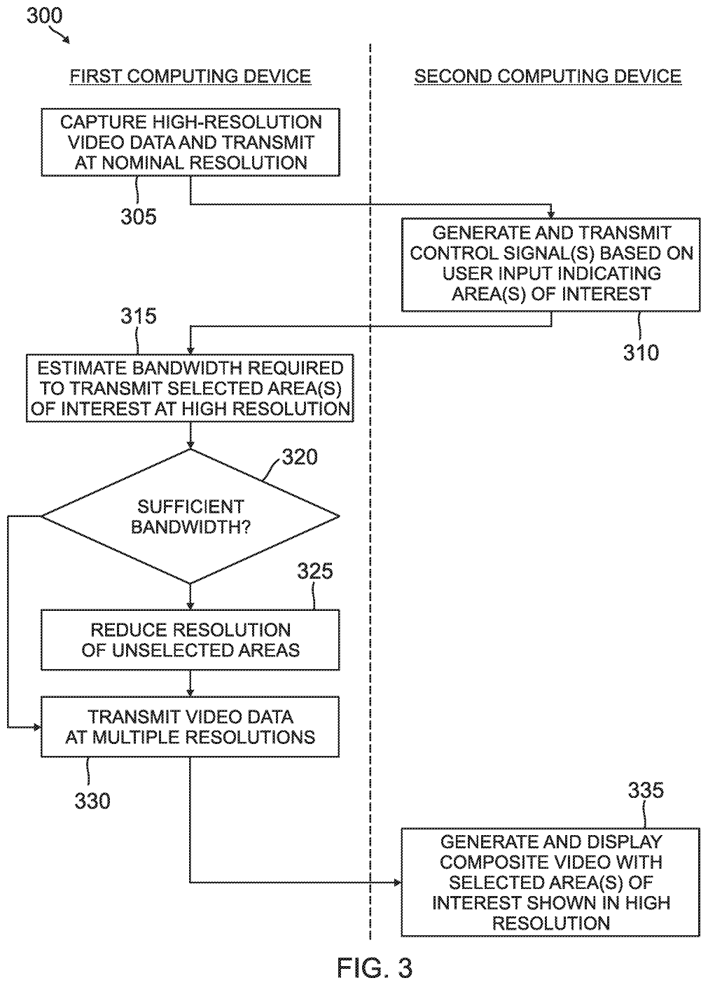

FIG. 3 illustrates an exemplary method 300 of operating the remote camera system 100 to transmit video data. In a first step 305, the first computing device 105 and camera 110 capture high-resolution video data and transmit the video data at a nominal resolution to the second computing device 115. As described above, the frame rate and transmission rate of the video data can vary widely, depending on the circumstances. The resolution of the video data can also vary widely, depending on the circumstances. The nominal resolution of the video data is often affected or controlled by the available transmission bandwidth.

The second computing device 115 receives the video data and shows it on the display 120. A user operating the second computing device 115 can view the video and select one or more areas of interest. As described above, the user can designate parameters such as a location, shape and size of the area(s) of interest, using a variety of suitable user input devices and techniques.

Once the user has designated the area(s) of interest, in a step 310, the second computing device 115 generates and transmits one or more control signals to the first computing device 105. The control signal(s) indicate parameters such as the location, shape and size of the area(s) of interest selected by the user. In some cases, the selected area(s) of interest may comprise one or more specific objects, such as a structure, vehicle, person, etc. The control signal(s) may direct the first computing device 105 and camera 110 to track the object(s) of interest over time, in case the object(s) or the camera 110 should move.

Upon receiving the control signal(s), in a step 315, the first computing device 105 estimates the bandwidth required to transmit the selected area(s) of interest in high resolution to the second computing device 115. In a step 320, the first computing device 105 determines whether sufficient bandwidth is available to transmit the selected area(s) of interest in high resolution while continuing to transmit the remaining areas at nominal resolution.

If not, in a step 325, the first computing device 105 reduces the resolution of the unselected regions of the video, i.e., the areas that were not selected by the user as areas of interest. in some embodiments, the resolution is reduced starting with areas that are furthest from the selected area(s) of interest. The algorithm for the reduced resolution (e.g., display in lower than nominal resolution) can advantageously optimize the use of the available bandwidth to maintain an acceptable update rate for the user, while optimizing the resolution of the video. For example, in some cases, the algorithm displays the high-resolution area(s) selected by the user at the highest resolution and linearly decreases the resolution of the video as the distance away from the selected high-resolution area(s) increases.

In a step 330, the first computing device 105 transmits video data at multiple resolutions to the second computing device 115. The selected area(s) of interest are transmitted in high resolution, in accordance with the parameters indicated in the control signal(s). The unselected areas are transmitted at the nominal resolution of the remote camera system 100, if sufficient transmission bandwidth is available. Otherwise, at least some unselected areas (e.g., those located furthest from the area(s) of interest) are transmitted in low resolution, i.e., below the nominal resolution of the remote camera system 100. The first computing device 105 preferably optimizes the resolutions of the video data to transmit the selected area(s) of interest in high resolution, while transmitting the remaining, unselected areas at nominal resolution or low resolution to make best use of the available transmission bandwidth.

Upon receiving the video data transmitted at multiple resolutions, in a step 335, the second computing device 115 generates and displays a composite video image showing the selected area(s) of interest in high resolution. In some embodiments, the second computing device 115 generates the composite video image by combining multiple partial video files transmitted at different resolutions by the first computing device 105.

The systems and methods of the present application advantageously exhibit a number of distinctive features that overcome the drawbacks of existing image transmission systems. For example, unlike conventional foveal imaging approaches, the systems and methods of the present application place the control of the high-resolution portion of the image under the control of the user. In many UAV applications, for instance, these systems and methods advantageously improve a user's efficiency by both: (a) reducing the in-flight time the inspector expends to acquire a high-resolution image of an area of interest, and (b) eliminating the need for multiple flights to re-take pictures because the real-time images were of insufficient quality to enable the user to acquire the correct images and video during the first flight.

Using the systems and methods of the present application, a remote camera system can transmit image data at the optimal resolution(s) available to a user at another location. That is, images can be transmitted at the highest resolution possible while maintaining an acceptable update rate or download time. In some cases, the system may reduce the resolution of unselected portions of an image to achieve the optimal resolution(s) for transmission. A user can advantageously select a desired tradeoff between image resolution and update rate or download time.

Although specific embodiments have been illustrated and described herein, it will be appreciated by those of ordinary skill in the art that any arrangement, which can achieve the same purpose, may be substituted for the specific embodiments shown. Therefore, it is manifestly intended that this invention be limited only by the claims and the equivalents thereof.

### Example Embodiments

The present application discloses an image resolution and transmission system in which a user can advantageously select parameters such as location, shape and size of one or more areas of interest within a field of view of a remote camera, to be captured and transmitted in high resolution.

In one embodiment, a system comprises a first computing device coupled to a camera, the first computing device being configured to process data captured by the camera to create and transmit video and image data. The system further comprises a second computing device in communication with the first computing device and coupled to a display, the second computing device being configured to receive and display video and image data transmitted by the first computing device. The second computing device is configured to generate and transmit one or more control signals, in response to user input, designating a location, shape and size of one or more selected areas of interest within a field of view of the camera. The first computing device is configured, upon receiving the control signal(s), to transmit video data at multiple resolutions, with the selected area(s) of interest transmitted at high resolution and the unselected area(s) within the field of view of the camera transmitted at lower resolution, after automatically reducing the resolution of the unselected areas if needed to make use of the available transmission bandwidth. The second computing device is configured, upon receiving the video data transmitted at multiple resolutions, to generate and display composite video comprising a low-resolution area and one or more high-resolution areas of interest, as designated by the user.

The the first computing device and second computing device may comprise one or more of the following devices: an embedded computer, desktop computer, laptop computer, tablet, smart phone, PDA, or wearable device. The second computing device may comprise one or more of the following user input devices: a mouse, touchpad, arrow keys, joystick, capacitive touchscreen, resistive touchscreen, stylus, digital pen, or speech recognition. The first computing device and second computing device may be in communication via a telecommunications network comprising a wired network, wireless network, radio-based data transmission system modulated laser-based communication system, ACARS network, local area network (LAN), wide area network (WAN), personal area network (PAN), a distributed computing environment (e.g., a cloud computing environment), storage area network (SAN), Metropolitan area network (MAN), a cellular communications network, or the Internet. The first computing device and camera may be positioned at a fixed location remote from the second computing device. The first computing device and camera may be carried or mounted on a ground vehicle, watercraft or aircraft located remotely from the second computing device. The camera may have a resolution within a range of less than about 1 megapixel to about 50 megapixels. The control signal(s) designating a location, shape and size of the area(s) of interest may be generated in response to a user using one or more of the following selection tools: grid, free-form, or snap-to lasso. The selected area(s) of interest may comprise multiple independent regions of interest within the field of view of the camera,

In another embodiment, a method comprises capturing high-resolution video data with a first computing device having a camera, and transmitting the video data to a second computing device at first, nominal resolution. The method further comprises receiving one or more control signals from the second computing device, the control signal(s) designating a location, shape and size of one or more selected areas of interest within a field of view of the camera. The method further comprises, in response to receiving the control signal(s), estimating a bandwidth required to transmit the selected area(s) of interest at a second, high resolution and determining whether sufficient bandwidth is available to transmit the selected area(s) of interest at the second resolution while continuing to transmit the unselected area(s) within the field of view of the camera at the first resolution. If sufficient bandwidth is not available, the method further comprises reducing the resolution of at least some portions of the unselected area(s) to a third resolution that is lower than the first resolution. The method further comprises transmitting video data at multiple resolutions, with the selected area(s) of interest transmitted at the second resolution and the unselected area(s) within the field of view of the camera transmitted at: (a) the first resolution, (b) the third resolution, or (c) multiple resolutions including both the first resolution and the third resolution.

The method may further comprise tracking one or more objects of interest with the camera over time, wherein the object(s) of interest are determined based on the selected area(s) of interest designated by the user. The first computing device may comprise an embedded computer. The video data may be transmitted at the first resolution in accordance with NTSC or PAL standards. Reducing the resolution of at least some portions of the unselected area(s) may comprise linearly decreasing the resolution as the distance away from the selected area(s) of interest increases. Reducing the resolution of at least some portions of the unselected area(s) may comprise identifying an optimal resolution based on available bandwidth. Transmitting video data at multiple resolutions may comprise transmitting multiple partial video files at different resolutions.

In another embodiment, a method comprises receiving video data transmitted at a first, nominal resolution from a first computing device with a camera, at a second computing device with a display. The method further comprises generating, in response to user input, one or more control signals designating a location, shape and size of one or more selected areas of interest within a field of view of the camera, wherein the user input comprises a user selecting a desired location on the display of the second computing device with a user input device, thereby causing a selection window to appear on the display, which continues to expand in size as long as the user continues to press and hold the user input device. The method further comprises transmitting the control signal(s) to the first computing device; and receiving, from the first computing device, video data transmitted at multiple resolutions, with the selected area(s) of interest transmitted at a second, high resolution and the unselected area(s) within the field of view of the camera transmitted at: (a) the first resolution, (b) a third resolution lower than the first resolution, or (c) multiple resolutions including both the first resolution and the third resolution. The method further comprises, in response to receiving the video data at multiple resolutions, generating and displaying composite video comprising a low-resolution area and one or more high-resolution areas of interest, as designated by the user.

The second computing device may comprise one or more of the following user input devices: a mouse, touchpad, arrow keys, joystick, capacitive touchscreen, resistive touchscreen, stylus, digital pen, or speech recognition. The selection window may comprise a circle, square, or rectangle. Generating the composite video may comprise combining multiple partial video files transmitted at different resolutions by the first computing device.

In another embodiment, a system comprises a first computing device coupled to a camera, and a second computing device in communication with the first computing device and coupled to a display. The first computing device is configured to process data captured by the camera to create and transmit video and image data. The second computing device is configured to receive and display video and image data transmitted by the first computing device. The second computing device is also configured to generate and transmit one or more first control signals, in response to user input, indicating the presence of a point of interest within a field of view of the camera. The first computing device is configured, upon receiving the first control signal(s), to record a high-resolution still image and transmit a low-resolution version of the still image to the second computing device, which is configured to generate and transmit one or more second control signals, in response to user input, designating a location, shape and size of one or more desired areas of interest in the still image. Upon receiving the second control signal(s), the first computing device is configured to transmit high-resolution image data corresponding to the selected area(s) of interest. The second computing device is configured, upon receiving the high-resolution image data, to generate and display a composite still image comprising a low-resolution area and one or more high-resolution areas of interest, as designated by the user.

In another embodiment, a method comprises receiving low-resolution video data transmitted from a first computing device with a camera at a second computing device with a display; generating, in response to user input, one or more first control signals indicating the presence of a point of interest within a field of view of the camera; and transmitting the first control signal(s) to the first computing device. The method further comprises receiving a low-resolution still image from the first computing device; generating, in response to user input, one or more second control signals designating a location, shape and size of one or more selected areas of interest in the low-resolution still image; and transmitting the second control signal(s) to the first computing device. The method further comprises receiving, from the first computing device, high-resolution image data corresponding to the selected area(s) of interest; and in response to receiving the high-resolution image data, generating and displaying a composite still image comprising a low-resolution area and one or more high-resolution areas of interest, as designated by the user.

In another embodiment, a method comprises capturing and transmitting low-resolution video data with a first computing device having a camera; receiving one or more first control signals from a second computing device, the first control signal(s) indicating the presence of a point of interest within a field of view of the camera; and in response to receiving the first control signal(s), recording a high-resolution still image and transmitting a low-resolution version of the still image to the second computing device. The method further comprises receiving one or more second control signals from the second computing device, the second control signal(s) designating a location, shape and size of one or more selected areas of interest in the still image; and in response to receiving the second control signal(s), transmitting high-resolution image data corresponding to the selected area(s) of interest.

What is claimed is:

1. A system comprising:
a first computing device coupled to a camera, the first computing device being configured to process data captured by the camera to create and transmit video and image data; and
a second computing device in communication with the first computing device and coupled to a display, the second computing device being configured to receive and display video and image data transmitted by the first computing device,
wherein the second computing device is configured to generate and transmit one or more control signals, in response to user input, designating a location, shape and size of one or more selected areas of interest within a field of view of the camera,
wherein the first computing device is configured, upon receiving the control signal(s), to transmit video data at multiple resolutions, with the selected area(s) of interest transmitted at high resolution and the unselected area(s) within the field of view of the camera transmitted at lower resolution, after automatically reducing the resolution of the unselected areas if needed to make use of the available transmission bandwidth;
wherein the second computing device is configured, upon receiving the video data transmitted at multiple resolutions, to generate and display composite video comprising a low-resolution area and one or more high-resolution areas of interest, as designated by the user.

2. The system of claim 1, wherein the first computing device and second computing device comprise one or more of the following devices: an embedded computer, desktop computer, laptop computer, tablet, smart phone, PDA, or wearable device.

3. The system of claim 1, wherein the second computing device comprises one or more of the following user input devices: a mouse, touchpad, arrow keys, joystick, capacitive touchscreen, resistive touchscreen, stylus, digital pen, or speech recognition.

4. The system of claim 1, wherein the first computing device and second computing device are in communication via a telecommunications network comprising a wired network, wireless network, radio-based data transmission system, modulated laser-based communication system, ACARS network, local area network (LAN), wide area network (WAN), personal area network (PAN), a distributed computing environment (e.g., a cloud computing environment), storage area network (SAN), Metropolitan area network (MAN), a cellular communications network, or the Internet.

5. The system of claim 1, wherein the first computing device and camera are positioned at a fixed location remote from the second computing device.

6. The system of claim 1, wherein the first computing device and camera are carried or mounted on a ground vehicle, watercraft or aircraft located remotely from the second computing device.

7. The system of claim 1, wherein the camera has a resolution within a range of less than about 1 megapixel to about 50 megapixels.

8. The system of claim 1, wherein the control signal(s) designating a location, shape and size of the area(s) of interest are generated in response to a user using one or more of the following selection tools: grid, free-form, or snap-to lasso.

9. The system of claim 1, wherein the selected area(s) of interest comprise multiple independent regions of interest within the field of view of the camera.

10. A method comprising:
capturing high-resolution video data with a first computing device having a camera, and transmitting the video data to a second computing device at first, nominal resolution;
receiving one or more control signals from the second computing device, the control signal(s) designating a location, shape and size of one or more selected areas of interest within a field of view of the camera; and
in response to receiving the control signal(s), estimating a bandwidth required to transmit the selected area(s) of interest at a second, high resolution and determining whether sufficient bandwidth is available to transmit the selected area(s) of interest at the second resolution while continuing to transmit the unselected area(s) within the field of view of the camera at the first resolution;
if sufficient bandwidth is not available, reducing the resolution of at least some portions of the unselected area(s) to a third resolution that is lower than the first resolution; and
transmitting video data at multiple resolutions, with the selected area(s) of interest transmitted at the second resolution and the unselected area(s) within the field of view of the camera transmitted at: (a) the first resolution, (b) the third resolution, or (c) multiple resolutions including both the first resolution and the third resolution.

11. The method of claim 10, further comprising tracking one or more objects of interest with the camera over time, wherein the object(s) of interest are determined based on the selected area(s) of interest designated by the user.

12. The method of claim 10, wherein the first computing device comprises an embedded computer.

13. The method of claim 10, wherein the video data is transmitted at the first resolution in accordance with NTSC or PAL standards.

14. The method of claim 10, wherein reducing the resolution of at least some portions of the unselected area(s) comprises linearly decreasing the resolution as the distance away from the selected area(s) of interest increases.

15. The method of claim 10, wherein reducing the resolution of at least some portions of the unselected area(s) comprises identifying an optimal resolution based on available bandwidth.

16. The method of claim 10, wherein transmitting video data at multiple resolutions comprises transmitting multiple partial video files at different resolutions.

17. A method comprising:
receiving video data transmitted at a first, nominal resolution from a first computing device with a camera, at a second computing device with a display;
generating, in response to user input, one or more control signals designating a location, shape and size of one or more selected areas of interest within a field of view of the camera, wherein the user input comprises a user selecting a desired location on the display of the second computing device with a user input device, thereby causing a selection window to appear on the display, which continues to expand in size as long as the user continues to press and hold the user input device;
transmitting the control signal(s) to the first computing device;
receiving, from the first computing device, video data transmitted at multiple resolutions, with the selected area(s) of interest transmitted at a second, high resolution and the unselected area(s) within the field of view of the camera transmitted at: (a) the first resolution, (b) a third resolution lower than the first resolution, or (c) multiple resolutions including both the first resolution and the third resolution; and
in response to receiving the video data at multiple resolutions, generating and displaying composite video comprising a low resolution area and one or more high-resolution areas of interest, as designated by the user.

18. The method of claim 17, wherein the second computing device comprises one or more of the following user input devices: a mouse, touchpad, arrow keys, joystick, capacitive touchscreen, resistive touchscreen, stylus, digital pen, or speech recognition.

19. The method of claim 17, wherein the selection window comprises a circle, square, or rectangle.

20. The method of claim 17, wherein generating the composite video comprises combining multiple partial video files transmitted at different resolutions by the first computing device.
